(19) United States
(12) Patent Application Publication
(10) Pub. No.: US 2020/0202739 A1
(43) Pub. Date: Jun. 25, 2020

(54) CUSTOMIZED RESOURCES FOR CORRECTING MISCONCEPTIONS

(71) Applicant: Pearson Education, Inc., New York, NY (US)

(72) Inventors: Llana WILLIAMS, Austin, TX (US); Melinda TUCKFIELD, Melbourne (AU)

(21) Appl. No.: 16/230,571

(22) Filed: Dec. 21, 2018

(51) Int. Cl. G09B 7/08; G09B 5/00; G06F 16/34

(52) U.S. Cl. CPC G09B 7/08; G06F 16/34; G09B 5/00

(57) ABSTRACT

Systems and methods of the present invention provide for providing access to an electronic learning activity comprising a challenge instruction and a GUI control configured to receive a first user input responding to the challenge instruction. If the first user input does not match a first correct response, the system identifies a misconception for the challenge instruction and first user input. The system then dynamically generates a group of users with the same user input, and a customized strategy for the group, including additional challenge instructions which, if responses match a second correct response, indicate the misconception is corrected.

### FIELD OF THE INVENTION

This disclosure relates to the field of systems and methods configured to provide learners with games or other activities to determine their understanding of a topic or subtopic. The systems and methods identify one or more misconceptions about the topic or subtopic, and provide customized resources for both instructors and learners to correct the misconceptions.

### SUMMARY OF THE INVENTION

The present invention provides systems and methods comprising one or more server hardware computing devices or client hardware computing devices, communicatively coupled to a network, and each comprising at least one processor executing specific computer-executable instructions within a memory that, when executed, cause the system to: provide access to an electronic learning activity comprising a challenge instruction and a GUI control configured to receive a first user input responding to the challenge instruction. If the first user input does not match a first correct response, the system identifies a misconception for the challenge instruction and first user input. The system then dynamically generates a group of users with the same user input, and a customized strategy for the group, including additional challenge instructions which, if responses match a second correct response, indicate the misconception is corrected.

The above features and advantages of the present invention will be better understood from the following detailed description taken in conjunction with the accompanying drawings.

### BRIEF DESCRIPTION OF THE DRAWINGS

FIG. 1 illustrates a system level block diagram for generating customized resources for an instructor and/or learner to correct common misconceptions related to a topic.

FIG. 2 illustrates a device level block diagram for generating customized resources for an instructor and/or learner to correct common misconceptions related to a topic.

FIG. 3 illustrates a network level block diagram for generating customized resources for an instructor and/or learner to correct common misconceptions related to a topic.

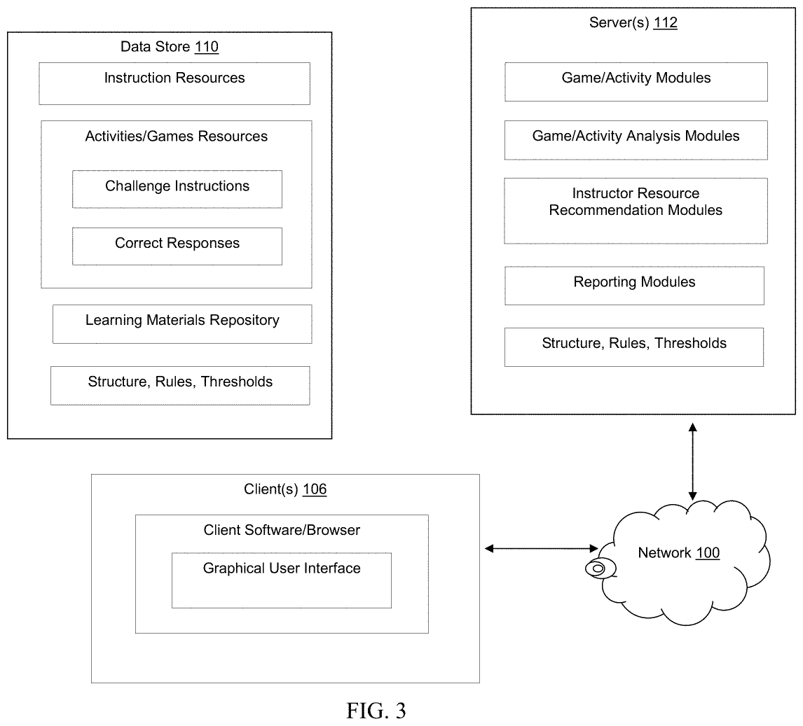

FIG. 4 illustrates a graphical user interface (GUI) for a non-limiting example embodiment of a system and method for generating customized resources for an instructor and/or learner to correct common misconceptions related to a topic.

FIG. 5 illustrates a GUI for a non-limiting example embodiment of a system and method for generating customized resources for an instructor and/or learner to correct common misconceptions related to a topic.

FIG. 6 illustrates a GUI for a non-limiting example embodiment of a system and method for generating customized resources for an instructor and/or learner to correct common misconceptions related to a topic.

FIG. 7 illustrates a GUI for a non-limiting example embodiment of a system and method for generating customized resources for an instructor and/or learner to correct common misconceptions related to a topic.

FIG. 8 illustrates a GUI for a non-limiting example embodiment of a system and method for generating customized resources for an instructor and/or learner to correct common misconceptions related to a topic.

FIG. 9 illustrates a GUI for a non-limiting example embodiment of a system and method for generating customized resources for an instructor and/or learner to correct common misconceptions related to a topic.

FIG. 10 illustrates a GUI for a non-limiting example embodiment of a system and method for generating customized resources for an instructor and/or learner to correct common misconceptions related to a topic.

FIG. 11 illustrates a GUI for a non-limiting example embodiment of a system and method for generating customized resources for an instructor and/or learner to correct common misconceptions related to a topic.

FIG. 12 illustrates a GUI for a non-limiting example embodiment of a system and method for generating customized resources for an instructor and/or learner to correct common misconceptions related to a topic.

FIG. 13 illustrates a GUI for a non-limiting example embodiment of a system and method for generating customized resources for an instructor and/or learner to correct common misconceptions related to a topic.

FIG. 14 illustrates a flow diagram representing method steps for a non-limiting embodiment of a method for generating customized resources for an instructor and/or learner to correct common misconceptions related to a topic.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

Recent research, currently in progress, concerns collecting digital evidence of what students are learning while participating in game play, then using this collection of digital evidence to make judgements about what the learners are comprehending, so as to provide the results of this collection of digital evidence to an instructor. Such research has been done at a conceptual level, but a challenge still remains to operationalize this concept into an actual product. As a non-limiting example, such a product may include three prongs: first, it should be highly accessible; second, it should be global; and finally, it should be in alignment with the conceptual research outlined above.

In many areas of instruction, it is important to instruct learners at an early age where possible. A non-limiting example of such instruction is seen in various math topics. For example, within mathematics, studies have shown that if learners have not mastered the fundamental concepts of math before completing primary or elementary school (e.g., grade 6), their chances of understanding and pursuing mathematics in high school and beyond are greatly decreased.

Several obstacles exist in making sure that these learners are able to master the fundamental concepts they are learning. Some organizations, especially those in high need areas, and/or those with a challenging population, may have a high turnover of instructors. Because of high turnover, many of the instructors may have a novice skill level in instructing, resulting in multiple problems. For example, instructors at a novice level of instruction may lack the resources that allow them to provide their learners with a rich, full instruction relating to the topic learned. Instead of providing and introducing sequential learning points in a way that ensures that learners have understood the concept and the reasoning behind the concepts, these novice instructors may rely only on the procedural methods with which they were taught.

Such procedural methods, and the lack of conceptual learning, may be particularly dull for the learners, removing any motivation for the learners to understand and master the concepts that make up the topic. Additionally, novice instructors may lack the means to identify any learning discrepancies relating to the topic being taught. For example, there are a number of research based misconceptions or gaps within such a procedural approach, and even if the instructor is able to identify the misconceptions of the learners, they may lack the resources to correct these misconceptions in a manner customized to each of the learners.

Thus, current systems and methods lack the means to provide instructors with the resources needed to understand and teach several concepts, and identify the learning gaps or misconceptions of the learners, while providing a means for the learners to learn in a conceptual, rather than a procedural manner, in a way that will engage the learners and motivate them to learn the related topic or sub topics.

The disclosed embodiments provide an optimal instruction environment made up of three distinct elements. First, the disclosed embodiments provide an instructor with targeted instructional resources to improve the instructors' skills and knowledge. These targeted instructional resources may follow a learning structure including a learning progression that provides learning points in sequence in a very conceptual way, so that as learners master a first concept, they may be introduced to related procedural methods, then move on to more complex concepts, and so forth.

Second, the disclosed embodiments provide a game or activity portion that moves through the conceptual progression (without the loss of instruction time due to formal testing or quizzes, for example), which measures a learner's understanding and learning through challenge questions or other challenges specifically designed to measure the learner's understanding and identify one or more misconceptions about the topic being evaluated. The disclosed system or the instructor may provide a game or other learning activity, including multiple user interactions each associated with a mastery of a specific skill and concept within a more general concept.

Third, the disclosed embodiments use the results of the activities to analyze and identify the learners' understanding and misconceptions, report these results to the instructor and/or parents of the learners, and dynamically provide additional instructions resources customized to the instructor and the learner to correct the misconceptions and progress to the next learning level. Thus, the disclosed system and methods utilize the results from the user interaction to determine the user's mastery of each of the specific skills and concepts within the more general concept, as well as the misconceptions that keep a learner from mastering a concept.

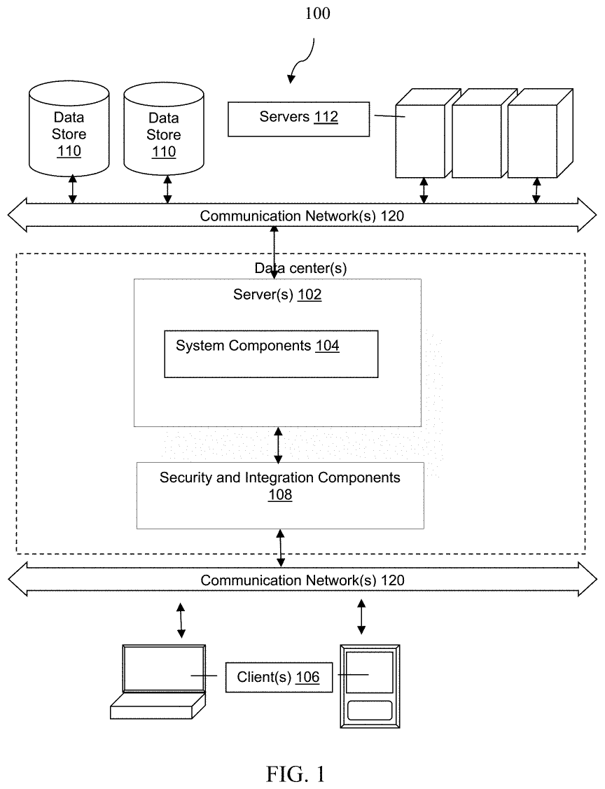

FIG. 1 illustrates a non-limiting example distributed computing environment 100, which includes one or more computer server computing devices 102, one or more client computing devices 106, and other components that may implement certain embodiments and features described herein. Other devices, such as specialized sensor devices, etc., may interact with client 106 and/or server 102. The server 102, client 106, or any other devices may be configured to implement a client-server model or any other distributed computing architecture.

Server 102, client 106, and any other disclosed devices may be communicatively coupled via one or more communication networks 120. Communication network 120 may be any type of network known in the art supporting data communications. As non-limiting examples, network 120 may be a local area network (LAN; e.g., Ethernet, Token-Ring, etc.), a wide-area network (e.g., the Internet), an infrared or wireless network, a public switched telephone networks (PSTNs), a virtual network, etc. Network 120 may use any available protocols, such as (e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

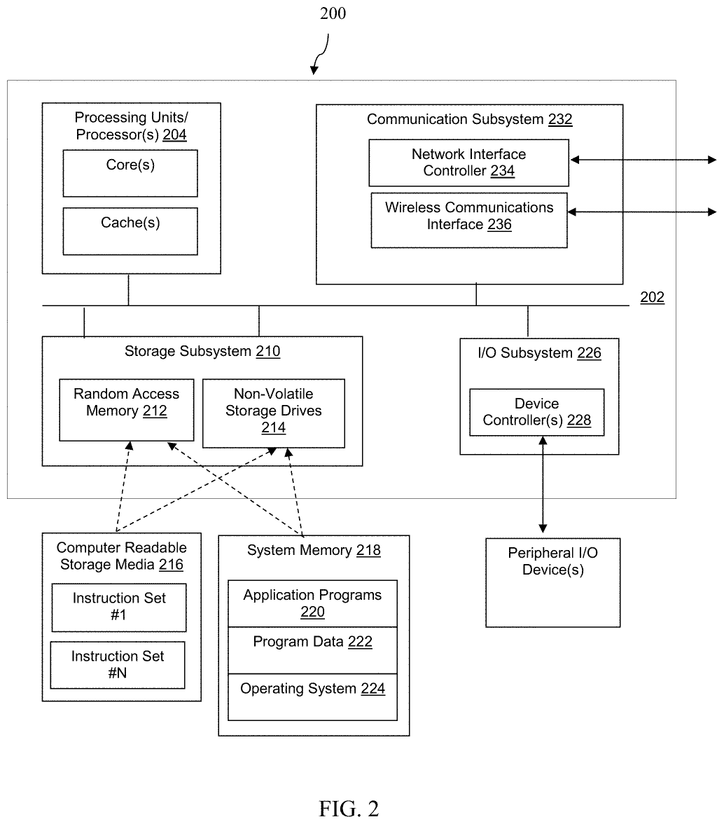

The embodiments shown in FIGS. 1-2 are thus one example of a distributed computing system and is not intended to be limiting. The subsystems and components within the server 102 and client devices 106 may be implemented in hardware, firmware, software, or combinations thereof. Various different subsystems and/or components 104 may be implemented on server 102. Users operating the client devices 106 may initiate one or more client applications to use services provided by these subsystems and components. Various different system configurations are possible in different distributed computing systems 100 and content distribution networks. Server 102 may be configured to run one or more server software applications or services, for example, web-based or cloud-based services, to support content distribution and interaction with client devices 106. Users operating client devices 106 may in turn utilize one or more client applications (e.g., virtual client applications) to interact with server 102 to utilize the services provided by these components. Client devices 106 may be configured to receive and execute client applications over one or more networks 120. Such client applications may be web browser based applications and/or standalone software applications, such as mobile device applications. Client devices 106 may receive client applications from server 102 or from other application providers (e.g., public or private application stores).

As shown in FIG. 1, various security and integration components 108 may be used to manage communications over network 120 (e.g., a file-based integration scheme or a service-based integration scheme). Security and integration components 108 may implement various security features for data transmission and storage, such as authenticating users or restricting access to unknown or unauthorized users,

As non-limiting examples, these security components 108 may comprise dedicated hardware, specialized networking components, and/or software (e.g., web servers, authentication servers, firewalls, routers, gateways, load balancers, etc.) within one or more data centers in one or more physical location and/or operated by one or more entities, and/or may be operated within a cloud infrastructure.

In various implementations, security and integration components 108 may transmit data between the various devices in the content distribution network 100. Security and integration components 108 also may use secure data transmission protocols and/or encryption (e.g., File Transfer Protocol (FTP), Secure File Transfer Protocol (SFTP), and/or Pretty Good Privacy (PGP) encryption) for data transfers, etc.).

In some embodiments, the security and integration components 108 may implement one or more web services (e.g., cross-domain and/or cross-platform web services) within the content distribution network 100, and may be developed for enterprise use in accordance with various web service standards (e.g., the Web Service Interoperability (WS-I) guidelines). For example, some web services may provide secure connections, authentication, and/or confidentiality throughout the network using technologies such as SSL, TLS, HTTP, HTTPS, WS-Security standard (providing secure SOAP messages using XML encryption), etc. In other examples, the security and integration components 108 may include specialized hardware, network appliances, and the like (e.g., hardware-accelerated SSL and HTTPS), possibly installed and configured between servers 102 and other network components, for providing secure web services, thereby allowing any external devices to communicate directly with the specialized hardware, network appliances, etc.

Computing environment 100 also may include one or more data stores 110, possibly including and/or residing on one or more back-end servers 112, operating in one or more data centers in one or more physical locations, and communicating with one or more other devices within one or more networks 120. In some cases, one or more data stores 110 may reside on a non-transitory storage medium within the server 102. In certain embodiments, data stores 110 and back-end servers 112 may reside in a storage-area network (SAN). Access to the data stores may be limited or denied based on the processes, user credentials, and/or devices attempting to interact with the data store.

With reference now to FIG. 2, a block diagram of an illustrative computer system is shown. The system 200 may correspond to any of the computing devices or servers of the network 100, or any other computing devices described herein. In this example, computer system 200 includes processing units 204 that communicate with a number of peripheral subsystems via a bus subsystem 202. These peripheral subsystems include, for example, a storage subsystem 210, an I/O subsystem 226, and a communications subsystem 232.

One or more processing units 204 may be implemented as one or more integrated circuits (e.g., a conventional micro-processor or microcontroller), and controls the operation of computer system 200. These processors may include single core and/or multicore (e.g., quad core, hexa-core, octo-core, ten-core, etc.) processors and processor caches. These processors 204 may execute a variety of resident software processes embodied in program code, and may maintain multiple concurrently executing programs or processes. Processor(s) 204 may also include one or more specialized processors, (e.g., digital signal processors (DSPs), outboard, graphics application-specific, and/or other processors).

Bus subsystem 202 provides a mechanism for intended communication between the various components and subsystems of computer system 200. Although bus subsystem 202 is shown schematically as a single bus, alternative embodiments of the bus subsystem may utilize multiple buses. Bus subsystem 202 may include a memory bus, memory controller, peripheral bus, and/or local bus using any of a variety of bus architectures (e.g. Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

I/O subsystem 226 may include device controllers 228 for one or more user interface input devices and/or user interface output devices, possibly integrated with the computer system 200 (e.g., integrated audio/video systems, and/or touchscreen displays), or may be separate peripheral devices which are attachable/detachable from the computer system 200. Input may include keyboard or mouse input, audio input (e.g., spoken commands), motion sensing, gesture recognition (e.g., eye gestures), etc.

As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like.

In general, use of the term “output device” is intended to include all possible types of devices and mechanisms for outputting information from computer system 200 to a user or other computer. For example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or non-visual displays such as audio output devices, etc. As non-limiting examples, output devices may include, indicator lights, monitors, printers, speakers, headphones, automotive navigation systems, plotters, voice output devices, modems, etc.

Computer system 200 may comprise one or more storage subsystems 210, comprising hardware and software components used for storing data and program instructions, such as system memory 218 and computer-readable storage media 216.

System memory 218 and/or computer-readable storage media 216 may store program instructions that are loadable and executable on processor(s) 204. For example, system memory 218 may load and execute an operating system 224, program data 222, server applications, client applications 220, Internet browsers, mid-tier applications, etc.

System memory 218 may further store data generated during execution of these instructions. System memory 218 may be stored in volatile memory (e.g., random access memory (RAM) 212, including static random access memory (SRAM) or dynamic random access memory (DRAM)). RAM 212 may contain data and/or program modules that are immediately accessible to and/or operated and executed by processing units 204.

System memory 218 may also be stored in non-volatile storage drives 214 (e.g., read-only memory (ROM), flash memory, etc.) For example, a basic input/output system (BIOS), containing the basic routines that help to transfer information between elements within computer system 200 (e.g., during start-up) may typically be stored in the non-volatile storage drives 214.

Storage subsystem 210 also may include one or more tangible computer-readable storage media 216 for storing the basic programming and data constructs that provide the functionality of some embodiments. For example, storage subsystem 210 may include software, programs, code modules, instructions, etc., that may be executed by a processor 204, in order to provide the functionality described herein. Data generated from the executed software, programs, code, modules, or instructions may be stored within a data storage repository within storage subsystem 210.

Storage subsystem 210 may also include a computer-readable storage media reader connected to computer-readable storage media 216. Computer-readable storage media 216 may contain program code, or portions of program code. Together and, optionally, in combination with system memory 218, computer-readable storage media 216 may comprehensively represent remote, local, fixed, and/or removable storage devices plus storage media for temporarily and/or more permanently containing, storing, transmitting, and retrieving computer-readable information.

Computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 200.

By way of example, computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 216 may include, but is not limited to, Zip® drives, flash memory cards, universal serial bus (USB) flash drives, secure digital (SD) cards, DVD disks, digital video tape, and the like. Computer-readable storage media 216 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 200.

Communications subsystem 232 may provide a communication interface from computer system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 236 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

In some embodiments, communications subsystem 232 may also receive input communication in the form of structured and/or unstructured data feeds, event streams, event updates, and the like, on behalf of one or more users who may use or access computer system 200. For example, communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 232 may output such structured and/or unstructured data feeds, event streams, event updates, and the like to one or more data stores that may be in communication with one or more streaming data source computers coupled to computer system 200.

The various physical components of the communications subsystem 232 may be detachable components coupled to the computer system 200 via a computer network, a FireWire® bus, or the like, and/or may be physically integrated onto a motherboard of the computer system 200. Communications subsystem 232 also may be implemented in whole or in part by software.

Due to the ever-changing nature of computers and networks, the description of computer system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

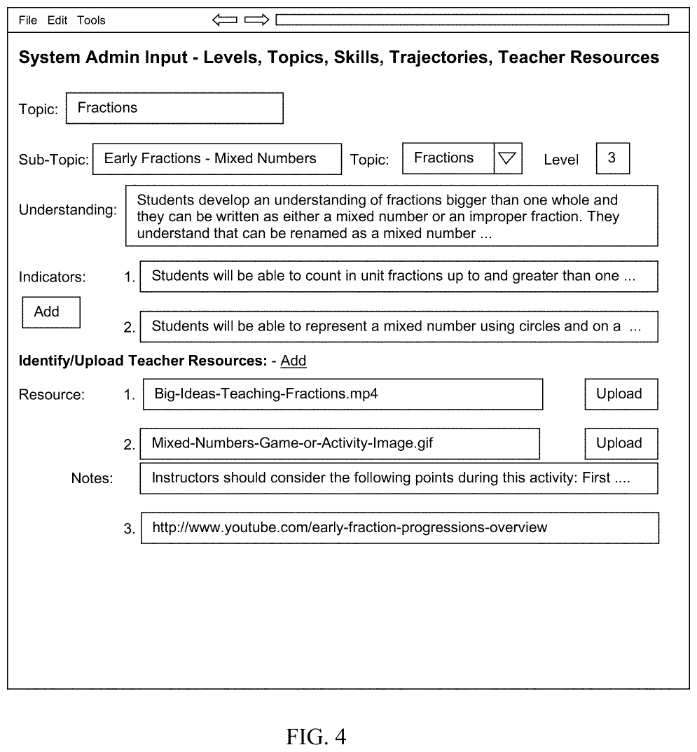

Server 112 may generate at least one GUI, such as the non-limiting example GUIs in FIGS. 4-13, which are designed to receive required instructions, software rules, and/or system data (e.g., the structure, software rules and parameters, scoring structure, learning centers, defined thresholds, etc., described below) from a software developer or any other system developer or other system administrator, referred to herein as a system admin. One or more GUI controls may be rendered on the GUI allowing the system admin to update the software instructions, or to provide any of the required system data described below.

In some embodiments, the disclosed system may automatically import the required data using database imports, website crawls, artificial intelligence, machine learning, or any other means of identifying, analyzing, and/or storing the data described below. This automatic generation of the definitions, materials, and other resources in the embodiments described herein, may be combined in any way with the user input described herein to provide a repository of learning materials specifically targeting learning misconceptions automatically identified by the disclosed system.

As a non-limiting example, such as that seen in FIG. 4, the GUI(s) may include one or more GUI controls configured to receive, from a system admin, one or more topics defined by the system admin to be provided by an instructor, and learned by a learner. As a non-limiting example, a system admin may provide data for one or more mathematics presentations available through the disclosed system, and may define the topic as any combination of mathematics and/or “Fractions,” as seen in FIG. 4.

As seen in FIG. 4, the GUI may further include one or more GUI controls configured to receive, from a system admin, one or more sub topics, or related topics associated with the defined topic. The GUI may further include means to associate the sub topic or related topic with a previously defined topic, sub topic, or related topic. In the example in FIG. 4, the system admin has input the sub topic(s) “Early Fractions-Mixed Numbers,” and has selected the topic “Fractions” from a menu of previously defined topics, thereby associating “Early Fractions” with the topic “Fractions” within the disclosed system. As another example, the sub topic “Mixed Numbers” may be a sub topic of the sub topic “Early Fractions,” which may, in turn, be a sub topic of “Fractions,” which may, in turn, be a sub topic of mathematics, and so forth.

The sub topic or related topic may further be associated with a learning level defined in the system, as described below. In some embodiments, this learning level may represent a game level, or a “room” within the games or activities described herein. In the example in FIG. 4, the system admin has selected a learning level of 3. As a non-limiting example, the learning level associated with topic Fractions, and/or the sub topic “Early Fractions,” may be associated within the system, and in the games below as “game level [or room] 3—Mixed Numbers.”

In some embodiments (not shown in FIG. 4), the system admin may further define a learning trajectory associated with the sub topic or related topic defined by the system admin. The system admin may define a learning trajectory that allows instructors to provide resources with which to instruct their learners according to a specific topic and/or sub topic, thereby allowing learners to master specific concepts. As a non-limiting example, the learning trajectory associated with the topic “Fractions,” and the sub topics “Early Fractions,” and/or “Mixed Numbers” may include “The meaning of fractions.”

As seen in FIG. 4, the GUI may further include one or more GUI controls configured to receive, from a system admin, one or more learning objectives for the topic, sub topic, learning level, and/or learning trajectory that defines the objective associated with the learner's understanding. In the example in FIG. 4, the system admin has input a learning objective for Early Fractions/Mixed Numbers as follows: “Students develop an understanding of fractions bigger than one whole and they can be written as either mixed numbers or improper fractions. They understand that can be renamed as a Mixed number without affecting their size and vice versa.”

As seen in FIG. 4, the GUI may further include one or more GUI controls configured to receive, from a system admin, one or more indicators, which define skills or topics, associated with the learning objectives for the learning trajectory, which the learner should master in order to move past the current level, learning trajectory, and/or learning objectives. As noted below, these indicators may be used to determine if the learner has mastered fundamental principles related to topics, thereby preparing the learner to move to a more advanced level within the disclosed system. Similarly, the learners' inability to demonstrate mastery of these skill sets may indicate a misunderstanding, learning gap, or misconception of the concepts taught, as explored in more detail below. The current disclosure should in no way limit the number of indicators associated with a topic, sub topic, learning level, learning trajectory, and/or learning objectives. Thus, the disclosed system may include one or more GUI controls configured to receive multiple indicators from the user (e.g., by use of the “Add” button seen in FIG. 4).

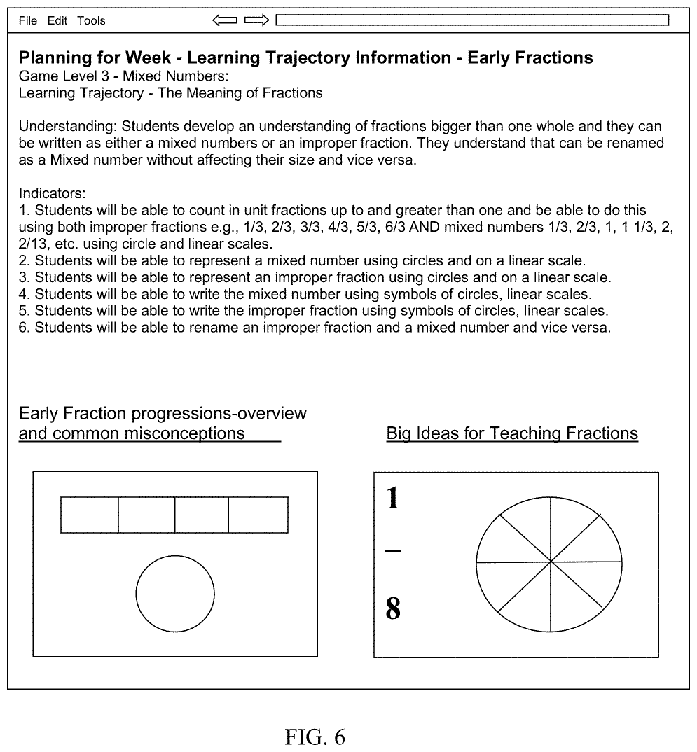

In the example in FIG. 4, the system admin has input “Students will be able to count in unit fractions up to and greater than one and be able to do this using both improper fractions e.g., ⅓, ⅔, 3/3, 4/3, 5/3, 6/3 AND mixed numbers ⅓, ⅔, 1, 1⅓, 1⅔, 2, 2⅓ etc., using circle and linear scales” as a first indicator associated with the Early Fractions/Mixed Numbers subtopic within the Math/Fractions topic, and further associated with the appropriate learning level, learning trajectory, and learning objectives associated with this topic/sub topic. In this example embodiment, the user has selected the “Add” button to input an additional indicator, “Students will be able to represent a mixed number using circles and on a linear scale.” The system admin may continue inputting associated indicators, such as shown in FIG. 6, which demonstrates 4 additional indicators input by the system admin.

As seen in FIG. 4, the GUI may further include one or more GUI controls configured to receive, from a system admin, one or more learning resources, which are associated with the related topic, sub topic, learning level, learning objective, learning trajectory, indicators, etc. These resources may be provided to the instructor to assist the instructor in generating lesson plans. These resources may include any multimedia, electronic files, instruction aids, or any other resources that may be used by the instructor within the disclosed system to better understand the subject matter within the topic, the sub topic, and/or the related topic, as well as the learning level(s), learning objectives, learning trajectories, and/or indicators.

In the example in FIG. 4, the system admin has provided various multimedia as resources for the instructor related to the topic and/or any subtopics. In a first non-limiting example (resource #1), the system admin has selected, possibly from a local drive, a video file entitled “Big-Ideas-Teaching-Fractions.mp4.” In the non-limiting example demonstrated in FIG. 4, the system admin may click the “Upload” button in order to upload the selected video file.

In a second non-limiting example (resource #2), the system admin has selected an image to be incorporated into a web page, instruction, report, game, homework and/or other activity associated with the topic, subtopic, learning trajectory, etc. In the non-limiting example demonstrated in FIG. 4, the system admin may click the “Upload” button in order to upload the selected image file. The system admin may further provide notes or other accompanying text explaining the provided media. In the second non-limiting example in FIG. 4, the system admin has provided text explaining the uploaded image.

In embodiments within the disclosed system, the system may automatically generate links to access the resources, and/or other means to download the resources (e.g., download a video or a PDF file). In a third non-limiting example of instructor resources provided by the system admin (resource #3 in FIG. x), the system admin provides the instructor with a link to a multimedia video available through a streaming website (e.g., YouTube). In this example, no additional link would be required, because the link is provided by the system admin. However, in this example, the system may automatically generate links and/or download options for downloading the video file Big-Ideas-Teaching-Fractions.mp4, or the image or text from the image file and accompanying text Mixed-Numbers-Game-or-Activity-Image.gif.

Server 112 may receive the user input from the provided GUI(s), including the topic, the related/sub topic, the learning level(s), the learning objectives, the learning trajectory, and/or the indicators defined by the system admin, as well as any related resources uploaded or otherwise provided to the disclosed system, and generate the links for accessing and/or downloading this information. Server 112 may then store this data, with any combination of associations, in data store 110.

For each of the topics, related/sub topics, learning objectives, learning trajectories, and/or indicators previously defined by the system admin, a number of associated research-based misconceptions or gaps in understanding may exist, and be identified by the system admin. The system admin may use the disclosed system, and specifically the games or other activities within the disclosed system described below, to provide instructors with means to identify, highlight, and remedy these misconceptions and gaps in understanding.

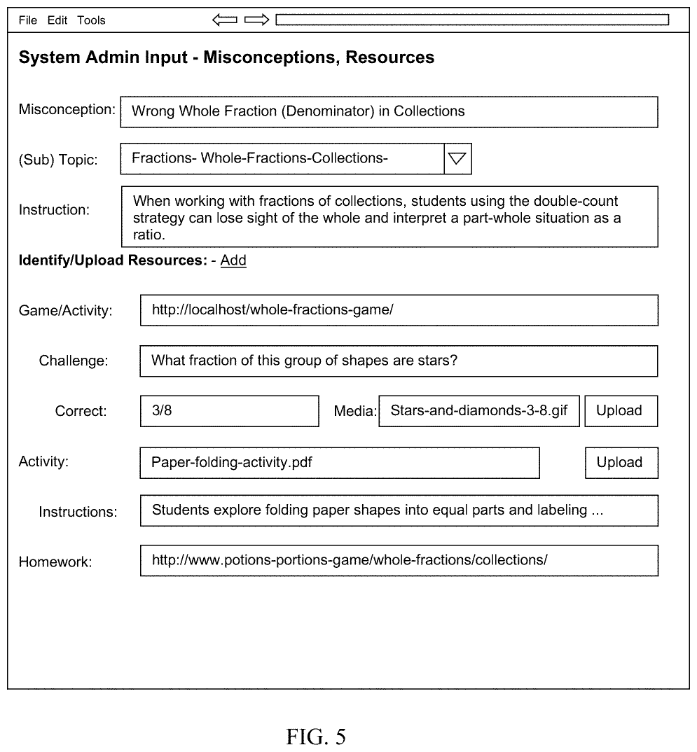

The GUI(s) may include one or more GUI controls configured to receive, from a system admin, one or more misconceptions associated with one or more defined topics, related/sub topics, learning levels, learning objectives, learning trajectories, and/or indicators. In the non-limiting example seen in FIG. 5, and continuing the non-limiting example above, the system admin may define a common misconception “Wrong Whole Fraction (Denominator) in Collections.”

The GUI may further include one or more GUI controls configured to receive, from a system admin, a selection of one or more topics, related/sub topics, learning levels, learning objectives, learning trajectories, and/or indicators to be associated with the defined misconception. In the non-limiting example seen in FIG. 5, the system admin has selected, from a dropdown menu GUI control, the topic(s) and/or sub topic(s) including “Fractions-Whole Fractions-Collections” to be associated in the system with the misconception “Wrong Whole Fraction (Denominator) in Collections.”

The GUI may further include one or more GUI controls configured to receive, from a system admin, one or more instructions associated with the misconception. These instructors may be used to overcome the misconception. In the example in FIG. 5, the system admin has provided the following instruction in association with the misconception “Wrong Whole Fraction (Denominator) in Collections:” “When working with fractions or collections, students using the double-count strategy can lose sight of the whole and interpret a part-whole situation as a ratio.”

After defining one or more misconceptions, associating the misconceptions with a specific topic, related/sub topic, learning level, learning objectives, learning trajectory, and/or indicators, and generating any additional instruction for instructors, the system admin may input, using the provided GUI, one or more challenges specifically targeted to determine whether or not a learner has mastered the indicators, or has not mastered the related concepts because of the common misconception defined by the system admin.

Non-limiting examples of such challenges may include any combination of multimedia, Internet resources, electronic documents, text instruction, etc. In the disclosed embodiments, these challenges may include, as non-limiting examples, interactive games demonstrating the learner's mastery of the subject matter, group or individual activities to reinforce correct principles and correct common misconceptions, and/or homework to reinforce the principles learned and determine whether the learner has mastered the subject matter and overcome the previously-identified misperceptions.

As seen in FIG. 5, the GUI may further include one or more GUI controls configured to receive input from a system admin including one or more resources to determine the learner's mastery of the subject matter associated with the identified common misconception. As previously noted, these resources may include any multimedia, text, or other resources used in games, activities, and/or homework assignments in order to overcome learners' misconceptions about the associated topic. In the non-limiting example in FIG. 5, the system admin has provided a URL (“http://localhost/whole-fractions-game”), accessible using the system's local network, for accessing a game testing the learners' understanding of whole fractions, which identifies the learners' misconceptions associated with whole fractions (denominators) in collections.

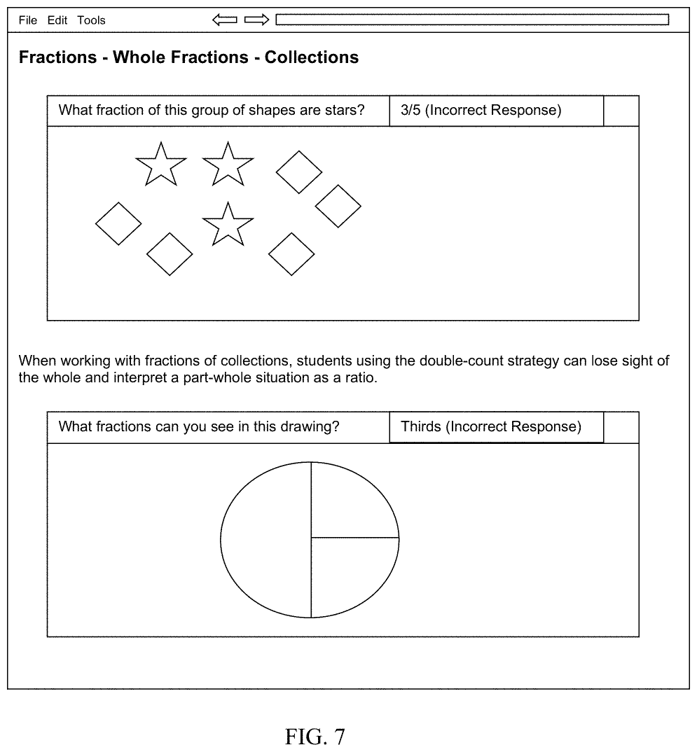

In this example, the system admin has provided, in association with the whole fractions game, a challenge question to be included in the electronic game to determine whether learners understand the denominator, or the whole fraction in a collection of items to which a fraction applies. Specifically, the system admin in FIG. 5 has input the challenge question “What fraction of this group of shapes are stars.” The system admin has further input and uploaded an image file “Stars-and-diamonds-3-8.gif,” to be associated with the input challenge question, providing the learner with a visual reference for the question. Finally, the system admin has provided a correct response to the challenge question. As seen in FIG. 7, in the uploaded image file, there are a total of 8 shapes, 3 of which are stars. Thus, the correct response to the challenge question is ⅜.

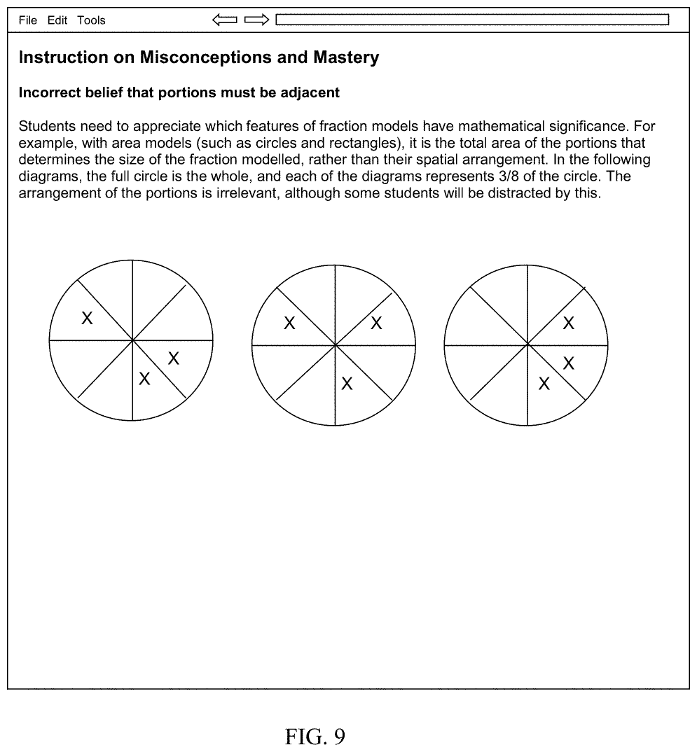

In the example in FIG. 5, the system admin has provided a resource for an individual or group activity, which may be used in a classroom environment for helping learners to overcome misperceptions associated with the identified topic and/or sub topic. Specifically, the system admin in this example has provided a portable document format (PDF) file titled “Paper-folding-activity.pdf,” which is used in the GUI demonstrated in FIG. 9. In some embodiments, such as that demonstrated in FIG. 5, the system admin may further provide instructions for the activity to be included within this document for the benefit of the instructor.

In FIG. 5, the system admin has provided instructions to conduct the activity associated with the received PDF file. Specifically, the system admin in FIG. 5 has input the instructions demonstrated in FIG. 9 to complete the paper folding activity, thereby providing the instructor with means for learners to gain a better understanding of the portions and the whole of the fraction.

In the example in FIG. 5, the system admin has provided a URL, accessible using the Internet, for accessing a whole fractions game specifically configured for testing the misconceptions associated with wrong whole fractions (denominators) in collections. This game may be used as homework to further identify the learners' misconceptions about the whole fraction or denominator in collections of items that make up the fraction.

In embodiments within the disclosed system, the system may automatically generate links to access the resources, and/or other means to download the resources (e.g., download challenge questions or a PDF file, etc.)

Server 112 may receive from the GUI the user input from the misconception, the associated topic, related/sub topic, learning level, learning objective(s), learning trajectory, and/or indicators, as well as the games, individual or group activities, challenge questions and answers, homework, as well as any related resources uploaded or otherwise provided to the disclosed system, and generate the links for accessing and/or downloading this information. Server 112 may then store this data, with any combination of associations, in data store 110.

Using the uploaded and stored data and files provided by the system admin (e.g., from the non-limiting example GUIs in FIGS. 4-5), the disclosed system may automatically, or with system admin input, generate a framework for the disclosed system, including necessary software or other instructions, rules, scoring, thresholds, and/or other structure for the uploaded and stored data.

This structure may include the software or other instructions, rules, scoring, thresholds etc., which the disclosed system uses to accomplish three specific goals: First, the system incorporates the provides games, individual and/or group activities, homework, etc., into a game or activity portion, used to measure the learners' understanding through game play or other activities. Second, using the data generated by user input while interacting with this game/activity portion, the structure utilizes instructions, rules, scoring, thresholds and other structure to analytically compile the results of the game portion and report the results to the instructor. Third, the disclosed system couples the results of the analysis in order to generate specific and targeted instructional resources which improve the learning experience for both the learners and the instructor, who can use the provided resources to improve teaching.

The system admin may define, as part of the system structure, one or more learning levels, which represent a learning progression of the learners. Each of these levels may assess, very specifically, some aspect of the learning progression. These learning levels may be based around specific areas of understanding such as the defined indicators referred to above. In other words, these learning levels may represent fundamental principles related to a given topic, that the learner must have a firm understanding of before moving on to the next level. As a non-limiting example within the disclosed embodiments, these learning levels may be represented by game levels (also referred to as “rooms” herein) within the games played by the learners.

The structure of the learning levels within the disclosed system may include one or more scoring schemas used to determine when each learner has a firm understanding of the principles in the learner's current level, and is ready to move on to the next level. In some embodiments, the learner may be scored according to their response to the challenges presented to them during game play. For example, if a challenge activity is presented to the user, and the user inputs the response matching the correct response stored in data store 110, the learner's score may increase by 1. However, if the learner's input response does not match the correct response stored in data store 110, the learner's score may not be increased, or may be decreased.

The scoring schema within the structure of learning levels may define a threshold score required by each learner before moving to the next learning level. If the user's score meets or exceeds this threshold (possibly by scoring enough points in the challenge activities), the system may determine, according to the defined structure, that the learner is ready to progress to the next learning level.

Thus, the system admin may define one or more learning levels. In some embodiments, the learning levels may be defined automatically by the system, according to artificial intelligence, machine learning, or any other means of identifying, analyzing, and/or storing the learning levels defined in the disclosed system.

With the structure, rules, scoring, thresholds, etc. of the disclosed system defined, a user, such as an instructor, may access the disclosed system, possibly using a GUI displayed on a client 106. In some embodiments, the user may have access through a customer of the disclosed system. For example, a school or school district may purchase access to the disclosed system, which may, in turn, provide access to the system for each of its instructors. The user may access the system and provide the system with account data about the user. In this example embodiment, the customer that purchased access to the system may also provide account data for each of the associated users.

As a non-limiting example used throughout this disclosure, the customer may be a school or school district, and the user and/or instructor associated with the customer may be a math instructor desiring to improve their class' understanding of fractions.

In some embodiments, this idea may be adapted so that the system is accessible using mobile devices such as tablets or phones, and is able to reach the widest possible audience globally. School systems in these embodiments may create a business model including free access to the games described below, where the district, school, and/or principle pays a subscription providing access to the system for their teachers. However, this example is non-limiting. The disclosed system may be used in any conceivable situation in which an instructor desires to identify learners' misperceptions of a specific topic or sub topic.

The user may then enter additional information establishing an account for each user. Continuing the non-limiting example above, the instructor may input personal account information, such as name, role as instructor, username or password information, physical or network address information, email address, social media profiles, etc. In this example, the instructor may further input the names of each of the learners, such as all of the learners in a math class, as well as any additional account information or other data associated with the instructor and each of the learners.

A user, such as the exemplary instructor, may access a GUI displayed on client 106. As a non-limiting example, the user may access a web page within a website representing the disclosed system using a web browser running on client 106. This web page may include means for the user to enter authentication information, such as entering a username and password into the appropriate GUI controls, such as username and password text boxes respectively (not shown). After the user submits the authentication information, client 106 may transmit the authentication data through network 120 to server 112. Server 112 may receive the transmission and authenticate the user to the system, possibly by matching the user name and password to a username and (possibly encrypted) password in data store 110.

The non-limiting example scenario provided below explains the use of the available resources within the disclosed system to accomplish the three goals of the disclosed system including measuring the understanding and progress of learners through gameplay, analytically compiling and reporting the results of the gameplay to the instructor, and providing targeted instructional resources for the instructor to improve both themselves and the learners' understanding.

Continuing the example above, once the instructor is authenticated, server 112 may access data store 110 to identify data associated in data store 110 with the authenticated user. Server 112 may then generate a GUI displaying this associated data. As non-limiting examples, such data may include concepts previously taught by the user, scores of learner users who have interacted with the system in learning the concepts taught, etc.

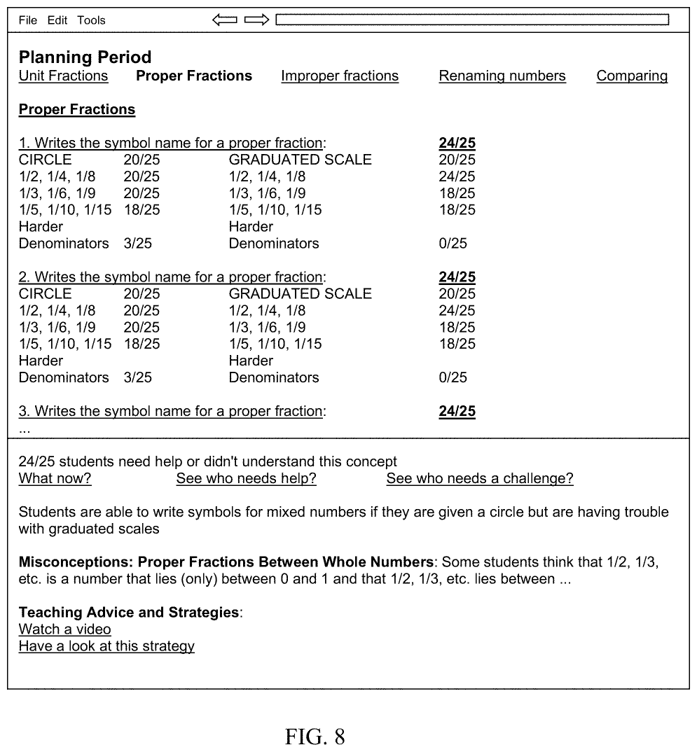

In addition to previously described data, server 112 may access data store 110 and execute a database command selecting available concepts that the user may use to teach. Server 112 may then generate, within the GUI, or as a separate GUI, a menu allowing the user to select any of the concepts that they desire to teach. As a non-limiting example, FIG. 8 shows several menu options that could be presented to an instructor, including topics that the user may need to access (e.g., Unit Fractions, Proper Fractions, Improper Fractions, Renaming Numbers, Comparing Fractions, etc., presented as a top navigation menu or tabs). After selecting a topic, the GUI may further include options for the instructor within each of the accessed topics. These options may provide instruction for both the instructor and the learners.

In some embodiments (not shown), server 112 may determine, based on the data associated in data store 110, that certain concepts have already been taught by the user. In these embodiments, server 112 may generate a menu including only those concepts that have not been previously taught.

Using the provided menu, the instructor may review the data displayed on the GUI, and select, from the menu, a concept that they desire to teach learners, and which will provide access to resources for preparing instruction. The content available through these links may include curated content including professional learning resources for the instructor, acting as a tutorial or refresher course, either providing fundamental teaching materials, and/or providing ideas for the instructor how to teach the principles in a different way. As a non-limiting example seen in FIG. 8, the “Teaching Advice and Strategies” section of the page includes menu options for “Watch a video,” and “Have a look at this strategy.”

Turning now to FIG. 6, the planning page for the instructor may include the presentation of the identified material related to the selected topic/subtopic, including the topic, related/sub topic, learning level, learning objective, learning trajectory, indicators, and available resources as previously generated. Continuing the non-limiting example above, the user may be a math instructor planning instruction dealing with fractions. The instructor, at the end of a week and in preparation for the next week, may use the available materials to plan and prepare for the next lesson. This user may access and be authenticated to the disclosed system, as described above. Server 112 may generate a GUI allowing the user to review previous math lessons (not shown), and after receiving the appropriate selection, server 112 may generate a further sub menu and so forth. For example, the math instructor user may select math and/or fractions from a presented menu, which may display a navigation such as that described above, providing access to various tabs or links allowing the instructor to specify sub topics associated with fractions, and so forth.

According to the instructor's selections, server 112 may automatically generate and render GUIs providing access to the resources provided by the system and/or the system admin. As a non-limiting example shown in FIG. 6, the instructor may have made menu or other selections navigating to materials for preparing a lesson on mixed numbers. As such, the instructor may have selected options and/or menu selections specifying math, fractions, early fractions, with a learning trajectory focused on the meaning of fractions at a game level of 3.

Server 112 may receive the selections and or navigation input from the instructor to assist the instructor in lesson planning, and generate an instruction page. To accomplish this, server 112 may access all data records and files in data store 110 matching the parameters of the selections and/or navigation from the instructor, and compile the matching/associated topics, related/sub topics, learning level, learning objectives, indicators, and instruction resources into a rendered web page. In the non-limiting example in FIG. 6, server 112 may select all data records, files, and/or other data associated in data store 110 with the selected math, fractions, early fractions, meaning of fractions learning trajectory, and game level 3 (mixed numbers), and generate a GUI such as that seen in FIG. 6. In this example, the data and files associated with these specific selections includes a learning objective/understanding text, 6 total associated indicators, and two associated learning resources, specifically two related videos.

The instructor may draw on any of the identified and displayed resources to prepare lessons on the selected topic. In this example, the instructor may watch the videos “Early Fraction progressions-overview and common misconceptions” and “Big Ideas for Teaching Fractions” shown in FIG. 6. After reviewing the learning focus of different levels, the instructor may select a game and level for learners to play within specific learning centers.

The instructor may then teach the principles associated with the selected topics and/or sub topics. Continuing the example above, the instructor may present a fractions lesson specifically focused on mixed numbers (at learning level 3), incorporating any of the associated learning objectives/understanding, indicators, or materials (e.g., the two videos described above) from the provided resources.

However, the disclosed embodiments should not be limited to seminar or lecture-based instruction. The disclosed system does not dictate how the provided material should be presented, but instead provides the instructor the flexibility to instruct the learners according to any preferred learning environment. Thus, the instructor may present the topic as whole group instruction, seat work, individual or small group work, homework, any combination thereof, etc. according to, or based on, the needs of the learners. Continuing the example above, on Monday of the following week, the instructor may introduce the topic of mixed numbers to the class.

The disclosed system then determines the retention of the introduced concept and instruction engaging the learners in related activities. Rather than having to lose instructional time in the classroom to administer tests, the instructor may provide activities that include high learner engagement. The disclosed system provides, in real time, the same fidelity of comprehension measurement, thereby informing the instruction. As learners participate in the associated activities, the disclosed system gathers data about their comprehension of the selected topic for the instructors to understand where their learners are in much the same manner as a test or a quiz, without the need to stop learners and formally test them.

Using the resources provided by the system admin, the instructor may then have the learners participate in at least a portion of one or more activities associated with the selected topic taught by the instructor. In some embodiments, the instructor may separate the learners into groups, having each group participate in one or more games and/or other activities associated with the selected topic or sub topic within the system. Server 112 may identify all resources associated with the identified topic/sub topic, and display the game or other resources to the learners, possibly using a GUI displayed on a client computing device 106. The game or activity may iterate through the associated challenge questions or other challenges provided by the system admin, each associated with a common misconception and/or indicator for the topic or sub topic.

Continuing the non-limiting example above, and as seen in FIG. 7, the system admin may have provided one or more games and/or activities, associated within the system with the instructor's selections/navigation, providing challenge questions related to fractions, and specifically whole fractions and collections. In this example, server 112 has executed a database command selecting all challenge questions/challenges and associated correct answers used to assess the learners' understanding of fractions, whole fractions, and/or collections, and identify any misconceptions about whole fractions (i.e., denominators) in collections.

In FIG. 7, the instructor has given a learner an assignment to access the whole fractions game found at http://localhost/whole-fractions-game/as provided by the system admin. In response to this access, server 112 may generate a GUI similar to that seen in FIG. 7, iterating through each of the challenge questions or other challenges designed to assess the learners' understanding of, and any misconceptions related to, whole fractions. As seen in FIG. 7, server 112 has loaded the image file Stars-and-diamonds.gif, as well as the challenge question “What fraction of this group of shapes are stars?”

Server 112 may further render a GUI control for receiving a response from the learner. Continuing the non-limiting example above, the learner in FIG. 7 is provided with a text box in which to enter their response to the challenge (“What fraction of this group of shapes are stars?”). In the example shown in FIG. 7, the learner has input ⅗, rather than the correct response of ⅜.

As each learner participates in the selected activity, server 112 may gather data in the background as a measurement of the learners' comprehension, thereby allowing instructors to understand each learner's comprehension and any learning gaps or misconceptions within the associated and selected topic. This data gathering may be equal to or better than a formal test or quiz, because the learner is more engaged, and the relevant instructions are not interrupted by a formal test of their knowledge.

The response from the user input may be transmitted to server 112, which may receive the response and select, from data store 110, the associated data defining the correct response to the challenge activity. Server 112 may then analyze the input user response to determine if it matches the correct response. If so, server 112 may select data associated with the identified learner, and increase a score associated with the learner. Conversely, if the user input does not match the correct response, the learner's score may remain the same or be decreased.

For each challenge question or other challenge for which the learner has input a response that did not match the correct response, server 112 may identify, within data store 110, one or more misconceptions associated in data store 110 with the challenge/question and incorrect response. As seen in FIG. 7, in some embodiments, server 112 may identify incorrect responses, and associated common misconceptions, and display the misconception in real time on the GUI, so that the instructor and/or learner are provided feedback in real time regarding their misconceptions.

The system may iterate through all challenge questions or other challenges for each of the challenge activities associated with the relevant selected topic, repeating the process described above: determining if the user input for each of the challenge questions in these activities match the stored correct response, and increasing or decreasing the user's score accordingly.

In some embodiments, once each learner has iterated through each of the challenges in each of the activities, server 112 may determine an aggregate score from which to identify and address learners' learning gaps or misconceptions related to the selected topic or sub topic. In these embodiments, server 112 may calculate a final score for each learner, summing the total of all user inputs that matched and did not match the correct responses identified in data store 110. Server 112 may then tally a final score for each of the learners that have completed all challenges related to the topic or subtopic.

The final score for each learner may then be analyzed. The final scores may be compared with a threshold score or other threshold defined in the structure of the disclosed system stored in data store 110, and defined by the system admin or the system itself. For each learner whose final score is greater than the defined threshold, the system may determine that the learner has a firm understanding of the selected topic, and may recommend that the learner be advanced to the next learning level.

For each learner whose score is below the defined threshold, server 112 may analyze the challenge questions and responses that did not match the correct stored responses for the challenge questions. Server 112 may then identify the common misconceptions associated in data store 110 with each of the incorrect responses. Using this identification of common misconceptions, along with the defined system structure, server 112 may group learners into groups (“learning centers”) based on common misconceptions or learning gaps.

Server 112 may then generate a report including the results of the challenge questions and/or other challenges within the activities completed by the learners. In other words, the results from data generated as the learners participated in the designated activities may be provided to a dashboard for the instructor to view a summary of the results of the learners' activities. The dashboard may further include navigation to additional learning resources, common misperceptions by the learners, and targeted teaching strategies to improve the instructor's understanding of the concepts and the common misconceptions.

As seen in FIG. 8, the report on the dashboard may include detailed results from the activities completed by the learners. In FIG. 8, the results may be grouped according to the indicators for the concepts to be learned from the activities (e.g., “Writes the symbol name for a proper fraction”). This summary of results allows the instructor to see very quickly in real time the status of understanding of the concepts taught.

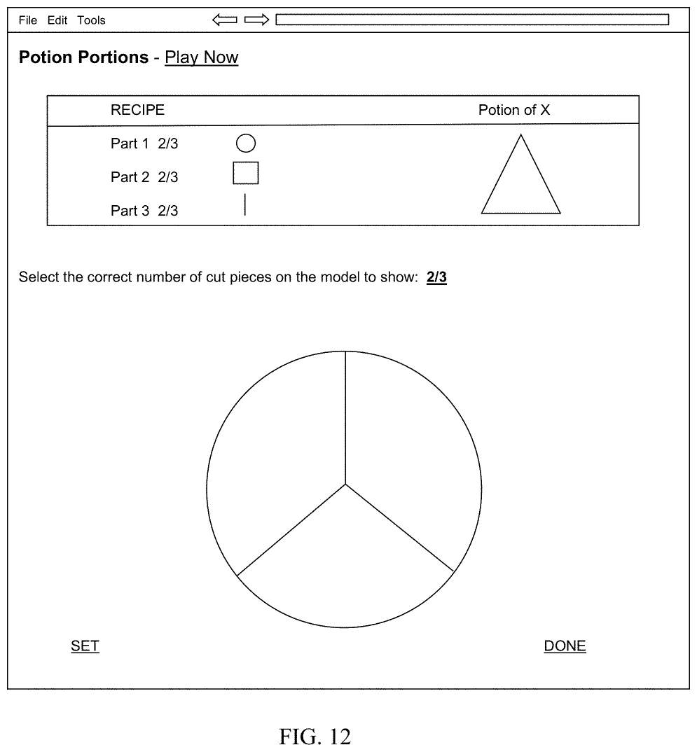

As a non-limiting example, FIG. 12 instructs learners to divide a circle into 3 equal pieces. If the learner had divided the circle using horizontal lines, the disclosed embodiments may recognize the incorrect response of horizontal lines within a circle, which do not evenly divide the circle, as well as the misconception, which is that an area of a circle must be evenly divided in order to have a division of the circle into thirds. The system may automatically group learners into learning centers focused on this particular misconception, and may then further provide resources to the learning center including possible remedies for the misconceptions, such as instruction of properly dividing a circle into equal parts. The instructor may then present the recommended strategies and activities to the learners in the identified learning center.

In the disclosed system, the instructor may also be a learner. Thus, as seen in FIGS. 8-9, the report may include additional instructions for the instructor. In FIG. 8, the report includes a section titled “Teaching Advice and Strategies” including links to “Watch a video” and “Have a look at this strategy.”

In some embodiments, these teaching advice and strategies may be automatically generated by server 112, according to the misconceptions identified in the report. As a non-limiting example in FIG. 9, server 112 may identify a concept with which one or more learners are struggling (e.g., incorrect belief that portions must be adjacent). Server 112 may identify the concept according to incorrect responses associated with the misconception in data store 110, and further identify curated content including professional learning resources associated in data store 110 with the identified misconception. The instructor may use this curated content to refresh their knowledge, or generate new ideas for instruction. Thus, continuing the example above, for those learners who are not mastering the concept, the instructor may watch a video or review the principles in FIG. 9 to improve both the instructor's and their learners' mastery of the concept.

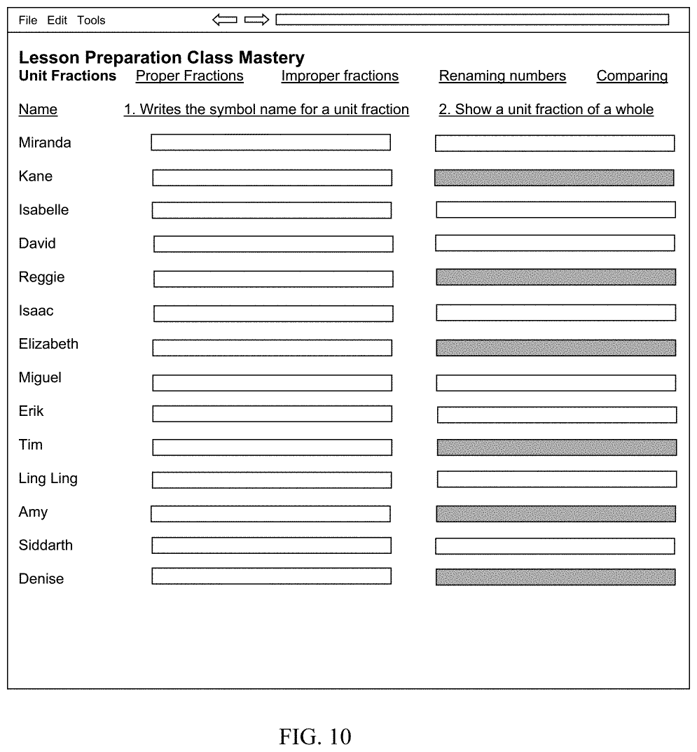

Turning now to FIGS. 8 and 10, the disclosed system may generate results according to the groupings around concepts, such as in FIG. 8, or may generate results according to individual learners, and each learners' mastery of the concepts tested within the activities. Using this report, the instructor may quickly, and in real time, see the current status of each of the learners, specifically which learners are understanding which concepts. This data may assist the instructor within the formative learning assessment cycle of instruction. Using this data, the instructor may differentiate instruction because of the detailed information received from each of the learners.

As seen in FIG. 8, the report may include the data collected during the activities and results of the activities completed by the learners, and may analytically compile these results and report these out to the instructor. The activities therefore specifically work through the progression, and inform the instructor of specific groups of learners or individuals that most likely have a particular misconception because they either selected something which indicated that, or made typical errors in answering or progressing through the activity.

Returning again to FIGS. 8 and 10, the report may include recommendations according to learning centers, or in other words, according to groupings of learners having common misconceptions. These recommendations may be automatically generated by the server by identifying one or more recommendations in data store 110 associated with the misconceptions identified for the grouping of learners. As non-limiting examples, these recommendations may include hands on activities used by the instructor to reteach the concept, thereby providing activities in addition to those initially used by the instructor and students.

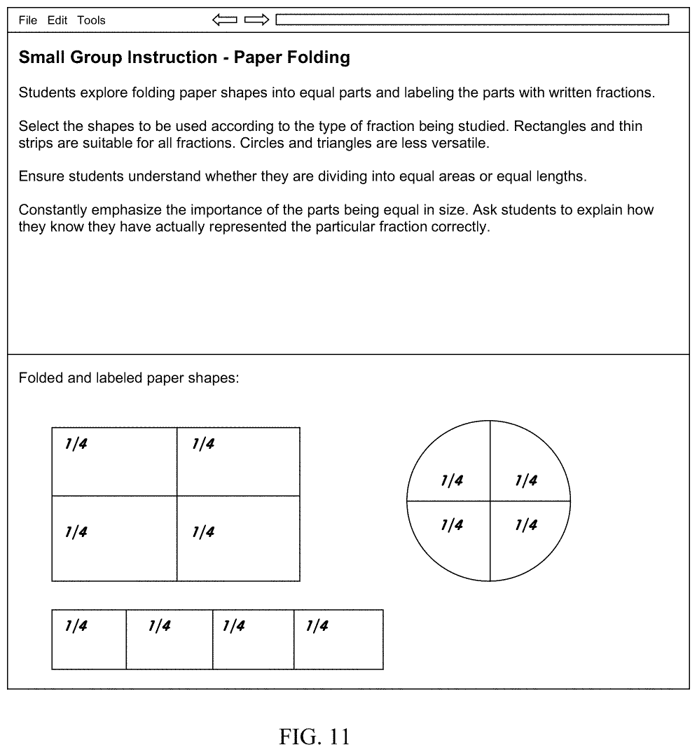

As a non-limiting example, in FIG. 11, server 112 may automatically identify a learning center around learners that have misconceptions about dividing shapes into equal areas or equal lengths. Server 112 may then automatically identify a learning resource for small group instruction around this misconception. Using the results of the report shown above, server 112 may automatically generate the content of the small group instruction for paper folding, according to the documents and content provided by the system admin in association with misconceptions regarding dividing shapes into equal areas and equal lengths.

Using the detailed information about each of the learners, in combination with the recommended content for each of the learning centers comprising groups of learners with common misconceptions, the instructor may generate a customized lesson plan, differentiating instruction for each of the learners (or the learners' learning centers) according to the customized data automatically provided by server 112.

The instructor may use the provided materials to generate a customized and dynamic lesson plan for each of the learning centers based on the materials automatically provided by server 112 in response to the learner input to the activities provided to teach the topic and sub topic-related concepts. The customized lesson(s) may include one or more activities for each of the learning centers, specifically addressing the misconceptions within the learning centers. Once the learning centers have been defined within the structure in the disclosed system, the system may generate a collection of games, individual or group activities, and/or homework for each of the identified learning centers. Thus, the challenge activities are not the only resource available to instructors to address learning gaps or misconceptions. The instructor may access, via a dashboard such as that seen in FIG. 8 additional materials that may include small group instruction, as an example.

Server 112 may then automatically generate content including specific instruction giving the learners in each learning center a clearer understanding of the associated topics or sub topics, and correcting the existing misconceptions. In the example embodiment in FIG. 11, server 112 has identified a common misconception regarding dividing shapes into equal areas or lengths, and has automatically identified (within data store 110) and provided the electronic document and/or other content describing a small group instruction activity for folding paper shapes into equal parts and labeling the parts with written fractions, as well as additional instruction for the small group leader for how to complete the activity and what concepts to emphasize. The instructor or a small group leader may then present the information within this content to the appropriate learning center.

In addition to generating content for group instruction, server 112 may further identify one or more homework resources associated in data store 110 with the misconceptions and/or learning centers, in order to provide a reinforcement of the concept that may be completed in a short period of time.

As a non-limiting example seen in FIG. 12, server 112 may identify a misconception or learning center focused on correctly identifying equal portions within a fraction, as demonstrated in a division of a shape. Using this identified misconception, server 112 may generate a recommended homework assignment as seen in FIG. 12, including a portion of an activity instructing learners to select a correct number of cut pieces on a model to show ⅔, or conversely, to identify ⅔ of the circle and write the appropriate symbol name.

The disclosed system may receive the user input from the homework activities, and repeat, as necessary, the process outlined above: identifying input from the learner that does not match the stored correct answer, identifying an associated learning gap or misconception, organizing learning centers around these learning gaps or misconceptions, and providing instructors resources for correcting the gaps or misconceptions. This process may be repeated until all learners have mastered the concepts within the learning level, and proceed to the next learning level.

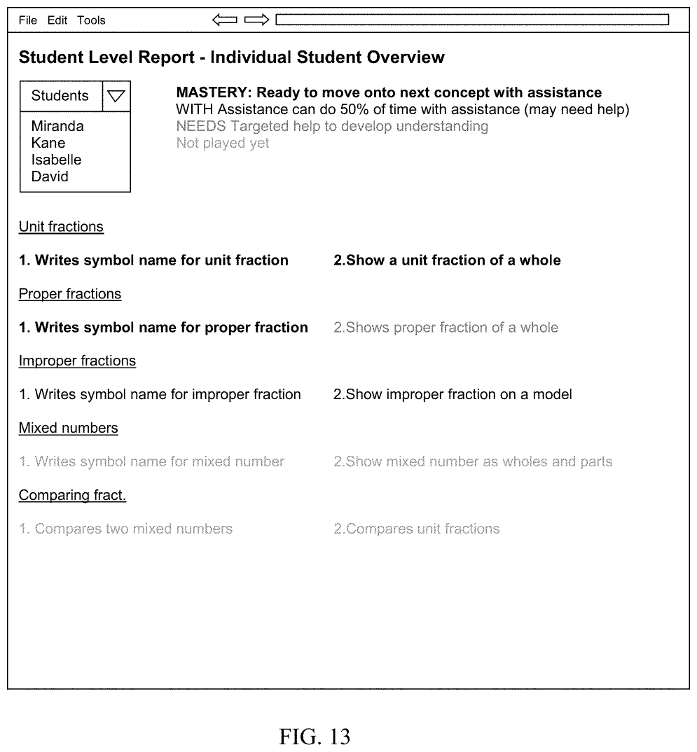

The results of each of these evaluations may be provided for teacher evaluation or for parent instructor conferences, for example, as demonstrated in FIG. 13. This may be used as a good communication tool, which may be shared with the parent to show concretely, the status of their learner according to concepts learned. These reports may provide real data, which is also observational as a instructor.

Additional embodiments may be envisioned. For example, in some embodiments, students who respond to challenge questions with correct answers may be credited with virtual coins. These coins may be used as credit for “purchasing” rewards within the disclosed system.

Additionally, other embodiments would not be limited to the non-limiting example embodiment including a school, school district, teachers, and students in a formal classroom setting. Additional embodiments may provide the disclosed system directly to parents to improve their children's learning, and assess their understanding and forth.

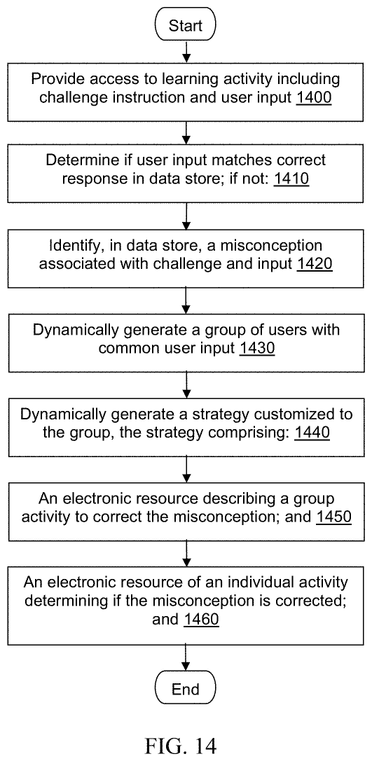

In summary, as seen in FIG. 14, the disclosed embodiments include systems and methods, the systems comprising a server, comprising a custom-designed special-purpose computing device coupled to a network and including at least one processor executing within a memory instructions comprising a specific device logic which, when executed cause the system to provide access to an electronic learning activity comprising: at least one challenge instruction; and a GUI control configured to receive a first user input responding to the challenge instruction (Step 1400). Responsive to a first determination that the first user input does not match a first correct response in a data store (Step 1410), the server identifies, within the data store, a misconception associated with the challenge instruction and the user input (Step 1420), and dynamically generates: a group comprising a plurality of users inputting the user input that does not match the first correct response (Step 1430); and a strategy customized to the group (Step 1440) and comprising: a first electronic resource describing a group activity to correct the misconception (Step 1450); and a second electronic resource comprising an individual activity comprising at least one additional challenge instruction, wherein responsive to a second determination that the at least one additional challenge instruction matches a second correct response in the data store, the misconception is corrected (Step 1460).

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A system, comprising a server, comprising a custom-designed special-purpose computing device coupled to a network and including at least one processor executing within a memory instructions comprising a specific device logic which, when executed cause the system to:
provide access to an electronic learning activity comprising:
at least one challenge instruction; and
a GUI control configured to receive a first user input responding to the challenge instruction;
responsive to a first determination that the first user input does not match a first correct response in a data store:
identify, within the data store, a misconception associated with the challenge instruction and the first user input;
dynamically generate:
a group comprising a plurality of users inputting the first user input that does not match the first correct response;
a strategy customized to the group and comprising:
a first electronic resource describing a group activity to correct the misconception; and
a second electronic resource comprising an individual activity comprising at least one additional challenge instruction, wherein responsive to a second determination that a second user input responding to the at least one additional challenge instruction matches a second correct response in the data store, the misconception is corrected.

2. The system of claim 1, wherein a system administrator generates the challenge activity, the correct response, and an association between the challenge activity, the correct response, and the misconception within the data store.

3. The system of claim 1, wherein the electronic learning activity and the individual activity comprise a game uploaded by a system administrator or available through a network.

4. The system of claim 1, wherein the first electronic resource is an electronic document uploaded by a system administrator or available through the network, and associated in the data store with the misconception:

5. The system of claim 1, wherein the second electronic resource is at least a portion of a game uploaded by the system administrator or available through the network as a homework assignment.

6. The system of claim 1, wherein responsive to the first determination that the first user input does not match a first correct response in the data store, the instructions cause the server to generate a report of results from the electronic learning activity.

7. The system of claim 6, wherein the report includes an assessment according to a topic tested within the electronic learning activity.

8. The system of claim 6, wherein the report includes an assessment according to at least one learner user that completed the electronic learning activity.

9. The system of claim 6, wherein the report includes at least one electronic targeted teaching resource, used by an instructor to correct the misconception.

10. A method, comprising the steps of:
providing, by a server comprising a custom-designed special-purpose computing device coupled to a network and including at least one processor executing instructions comprising a specific device logic within a memory, access to an electronic learning activity comprising:
at least one challenge instruction; and
a GUI control configured to receive a first user input responding to the challenge instruction;
responsive to a first determination that the first user input does not match a first correct response in a data store:
identifying, by the server, within the data store, a misconception associated with the challenge instruction and the first user input;
dynamically generating, by the server:
a group comprising a plurality of users inputting the first user input that does not match the first correct response;
a strategy customized to the group and comprising:
a first electronic resource describing a group activity to correct the misconception; and
a second electronic resource comprising an individual activity comprising at least one additional challenge instruction, wherein responsive to a second determination that a second user input responding to the at least one additional challenge instruction matches a second correct response in the data store, the misconception is corrected.

11. The method of claim 10, wherein a system administrator generates the challenge activity, the correct response, and an association between the challenge activity, the correct response, and the misconception within the data store.

12. The method of claim 10, wherein the electronic learning activity and the individual activity comprise a game uploaded by a system administrator or available through a network.

13. The method of claim 10, wherein the first electronic resource is an electronic document uploaded by a system administrator or available through the network, and associated in the data store with the misconception:

14. The method of claim 10, wherein the second electronic resource is at least a portion of a game uploaded by the system administrator or available through the network as a homework assignment.

15. The method of claim 10, further comprising the step of responsive to the first determination that the first user input does not match a first correct response in the data store, generating, by the server, a report of results from the electronic learning activity.

16. The method of claim 15, wherein the report includes an assessment according to a topic tested within the electronic learning activity.

17. The method of claim 15, wherein the report includes an assessment according to at least one learner user that completed the electronic learning activity.

18. The method of claim 15, wherein the report includes at least one electronic targeted teaching resource, used by an instructor to correct the misconception.
